(19) United States
(12) Patent Application Publication
(10) Pub. No.: US 2021/0312537 A1
(43) Pub. Date: Oct. 7, 2021

(54) CAR SHARING SYSTEM, SERVER AND COMPUTER READABLE RECORDING MEDIUM

(71) Applicant: TOYOTA JIDOSHA KABUSHIKI KAISHA, Toyota-shi (JP)

(72) Inventors: Yoshihiko TAKAHASHI, Miyoshi-shi (JP); Yuki TATSUMOTO, Miyoshi-shi (JP); Keisuke NISHINAKA, Nagoya-shi (JP); Hiroki TAMURA, Tokyo (JP); Yoshitaka NISHIKAWA, Nagakute-shi (JP); Kenji GOTOH, Tokyo (JP); Kota KATO, Abiko-shi (JP)

(73) Assignee: TOYOTA JIDOSHA KABUSHIKI KAISHA, Toyota-shi (JP)

(21) Appl. No.: 17/212,175

(22) Filed: Mar. 25, 2021

(30) Foreign Application Priority Data
Apr. 1, 2020 (JP) 2020-065933

(51) Int. Cl. G06Q 30/06; B60W 40/09; G06Q 20/10; G06Q 20/36

(52) U.S. Cl. CPC G06Q 30/0645; B60W 40/09; B60W 2540/30; G06Q 20/36; G06Q 20/102

(57) ABSTRACT

A car sharing system includes: a vehicle including a first processor including hardware, the first processor being configured to calculate a degree of safe driving of the vehicle by a driver, and output information about the calculated degree of safe driving; and a server including a second processor including hardware, the second processor being configured to acquire the information about the degree of safe driving, and determine whether to provide the vehicle to a car sharing service based on the acquired information.

The present application claims priority to and incorporates by reference the entire contents of Japanese Patent Application No. 2020-065933 filed in Japan on Apr. 1, 2020.

### BACKGROUND

The present disclosure relates to a car sharing system, a server and a computer readable recording medium.

JP 2019-101901 A discloses a technique related to a car sharing service for a plurality of users to share a vehicle.

### SUMMARY

There is a need for a car sharing system, a server and a computer readable recording medium that improve the quality of a car sharing service.

According to one aspect of the present disclosure, there is provided a car sharing system including: a vehicle including a first processor including hardware, the first processor being configured to calculate a degree of safe driving of the vehicle by a driver, and output information about the calculated degree of safe driving; and a server including a second processor including hardware, the second processor being configured to acquire the information about the degree of safe driving, and determine whether to provide the vehicle to a car sharing service based on the acquired information.

### BRIEF DESCRIPTION OF THE DRAWINGS

FIG. 1 is a schematic diagram illustrating a configuration of a wallet system according to an embodiment;

FIG. 2 is a block diagram illustrating a configuration of a wallet server illustrated in FIG. 1;

FIG. 3 is a block diagram illustrating a configuration of a settlement company server illustrated in FIG. 1;

FIG. 4 is a block diagram illustrating a configuration of a user terminal illustrated in FIG. 1;

FIG. 5 is a diagram illustrating a relationship between a wallet and settlement methods;

FIG. 6 is a block diagram illustrating a configuration of a vehicle illustrated in FIG. 1; and

FIG. 7 is a timing chart illustrating a flow of service management processing according to the embodiment.

### DETAILED DESCRIPTION

Hereinafter, a wallet system according to an embodiment will be described with reference to the drawings.

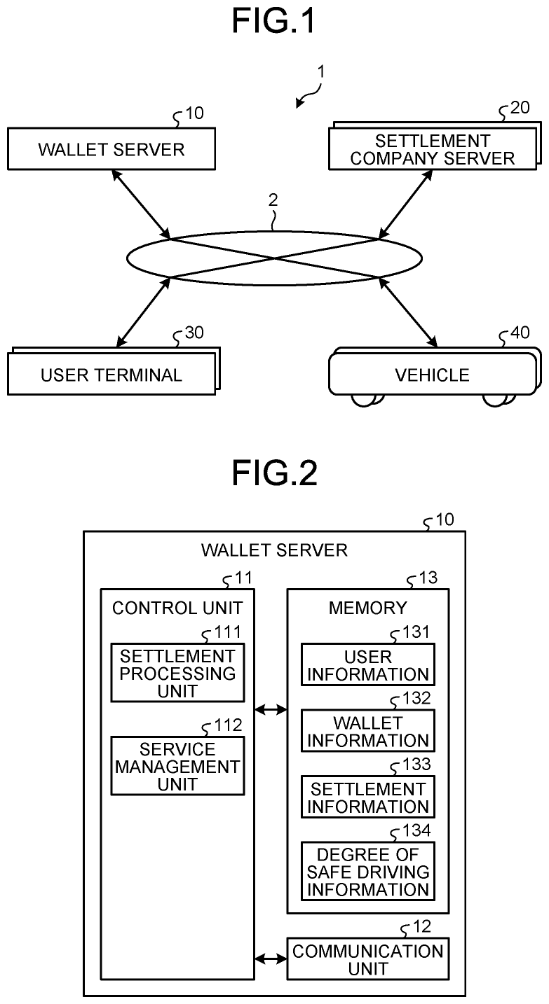

First, a configuration of the wallet system according to the embodiment will be described with reference to FIGS. 1 to 6.

As illustrated in FIG. 1, a wallet system 1 includes a wallet server 10, a settlement company server 20, a user terminal 30, and a vehicle 40 capable of communicating information with each other via a network 2.

The network 2 includes the Internet, a mobile phone line network, and the like. The network 2 is, for example, a public communication network such as the Internet, and may include other communication networks such as a wide area network (WAN), a communication network of a telephone such as a mobile phone, and a wireless communication network such as WiFi (registered trademark).

The wallet server 10 is an information processing device that collectively manages the wallet system 1, and is managed by an administrator of the wallet system 1. As illustrated in FIG. 2, the wallet server 10 includes a control unit 11, a communication unit 12, and a memory 13.

The control unit 11 includes a processor such as a central processing unit (CPU), a digital signal processor (DSP), or a field-programmable gate array (FPGA) having hardware, and a main memory such as a random access memory (RAM), a read only memory (ROM), or the like. The control unit 11 loads a computer program stored in the memory 13 into the work area of the main memory and executes the computer program, and controls each of the components and the like through the execution of the computer program to implement functions that meet a predetermined purpose. In the present embodiment, the control unit 11 functions as a settlement processing unit 111 and a service management unit 112 by executing a computer program. The functions of the settlement processing unit 111 and the service management unit 112 will be described below.

The communication unit 12 includes, for example, a local area network (LAN) interface board, a wireless communication circuit for wireless communication, and the like. The LAN interface board and the wireless communication circuit are connected to the network 2 such as the Internet, which is a public communication network. The communication unit 12 is connected to the network 2 and performs information communication with the settlement company server 20, the user terminal 30, and the vehicle 40 via the network 2.

The memory 13 includes a recording medium such as an erasable programmable ROM (EPROM), a hard disk drive (HDD), and a removable medium. Examples of the removable medium include a disc recording medium such as a universal serial bus (USB) memory, a compact disc (CD), a digital versatile disc (DVD), and a Blu-ray (registered trademark) disc (BD). The memory 13 may store an operating system (OS), various programs, various tables, various databases, and the like. In the present embodiment, the memory 13 stores user information 131, wallet information 132, settlement information 133, and degree of safe driving information 134 for each user who uses the wallet system 1.

The user information 131 is information about a user who uses the wallet system 1. As the user information 131, the user ID, password, user name, user contact information (for example, an address, a telephone number, an email address, etc.), a usage registration history, information about a payment method registered as a deposit method, information about a payment method registered as a settlement method, a code number at the time of settlement, and the like of a user who has registered to use the wallet system 1 may be exemplified. Out of the user information 131, the user ID and the password are used for authentication processing such as login to the wallet server 10.

The wallet information 132 is information about a wallet of the wallet system 1. The wallet indicates a virtual deposit/withdrawal account of electronic money. Examples of the wallet information 132 include a user ID, an electronic money balance, an electronic money deposit history, an electronic money usage history, and the like.

The settlement information 133 is information about settlement of the wallet system 1. Examples of the settlement information 133 include a user ID, a settlement method used for settlement (for example, electronic money payment (contactless settlement), scan payment, code payment, etc.), a settlement history, and the like.

The degree of safe driving information 134 is information about a degree of safe driving of the vehicle 40 by a user who uses the wallet system 1. The degree of safe driving indicates the degree of safe driving of the vehicle 40, and the higher the degree of safe driving, the higher the possibility that driving of the vehicle 40 by the user is safe. The degree of safe driving information 134 includes information about the vehicle 40 owned by the user and information about the degree of safe driving of the user.

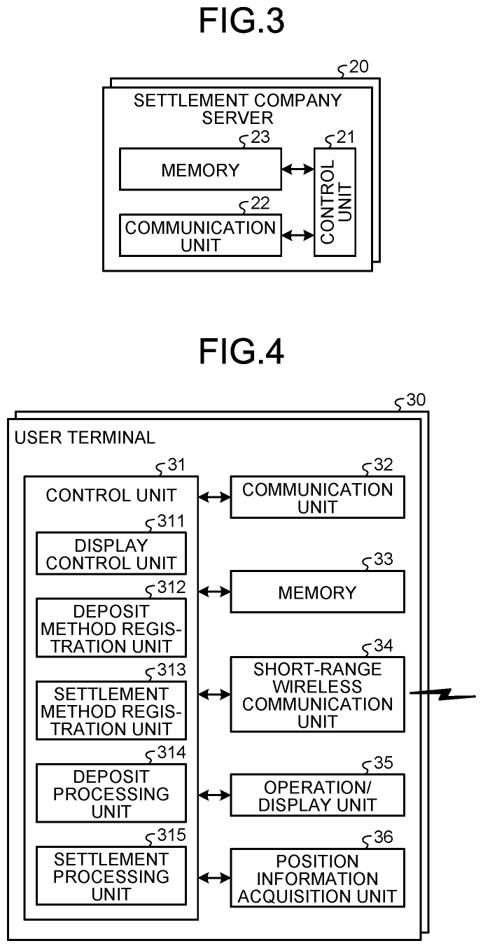

The settlement company server 20 is a server for managing an account and a credit card of a user, and is provided in a financial institution (for example, a bank, a shinkin bank, a credit union, a labor bank, etc.) and a credit card company. As illustrated in FIG. 3, the settlement company server 20 includes a control unit 21, a communication unit 22, and a memory 23. The control unit 21, the communication unit 22, and the memory 23 have physical configurations similar to the control unit 11, the communication unit 12, and the memory 13, respectively.

The memory 23 stores account information and credit card information for each of users who use the wallet system 1. As the account information, a name of a user, an account number, an account balance, a deposit/withdrawal history, and the like may be exemplified. Further, as the credit card information, a name of a user, a credit card number, a credit card expiry date, a usage limit, a card usage history, and the like may be exemplified.

The user terminal 30 is a computer terminal used by a user. As the user terminal 30, a smartphone, a mobile phone, a tablet terminal, a wearable computer, a personal computer, a route guidance device mounted on a vehicle, or the like owned by the user may be exemplified. The user terminal 30 may be any terminal as long as the terminal may communicate with the wallet server 10.

As illustrated in FIG. 4, the user terminal 30 includes a control unit 31, a communication unit 32, a memory 33, a short-range wireless communication unit 34, an operation/display unit 35, and a position information acquisition unit 36. The control unit 31, the communication unit 32, and the memory 33 have physical configurations similar to the control unit 11, the communication unit 12, and the memory 13, respectively. The control unit 31 functions as a display control unit 311, a deposit method registration unit 312, a settlement method registration unit 313, a deposit processing unit 314, and a settlement processing unit 315 through the execution of a computer program.

The display control unit 311 controls display contents on the operation/display unit 35. The display control unit 311 displays, on the operation/display unit 35 based on an operation of a user (a touch operation, a flick operation, etc.), a member registration screen when the user performs member registration, a login screen when the user logs in to the wallet server 10, a deposit screen when the user deposits electronic money to the wallet, a settlement screen when the user makes settlement, a usage history screen indicating a list of usage histories such as settlement, a payment history detail screen indicating details of the payment history, a code payment screen, a scan payment screen, and the like. In addition, the display control unit 311 transitions screen to screen based on an operation of a user. Various configurations may be adopted as screen configurations of the settlement screen, usage history screen, payment history details screen, and code payment screen.

The deposit method registration unit 312 registers a deposit method for depositing electronic money. Specifically, the deposit method registration unit 312 transmits a deposit method registration request to the wallet server 10 to cause the wallet server 10 to register a plurality of different payment methods (for example, a bank account, a credit card, a virtual credit card, etc.) operated by a plurality of companies as deposit methods to the wallet. The control unit 11 of the wallet server 10 that has received the deposit method registration request from the deposit method registration unit 312 stores the payment methods included in the deposit method registration request as the user information 131 in the memory 13, thereby registering the payment methods as the deposit method.

The deposit method registration unit 312 registers the payment methods to be registered as settlement methods also as deposit methods. That is, when a settlement method registration request is transmitted from the settlement method registration unit 313 to the wallet server 10, the deposit method registration unit 312 transmits a deposit method registration request, which causes the payment methods included in the settlement method registration request to be registered as deposit methods, to the wallet server 10. The control unit 11 of the wallet server 10 that has received the deposit method registration request from the deposit method registration unit 312 stores the payment methods included in the deposit method registration request as the user information 131 in the memory 13, thereby registering the payment methods as the deposit methods.

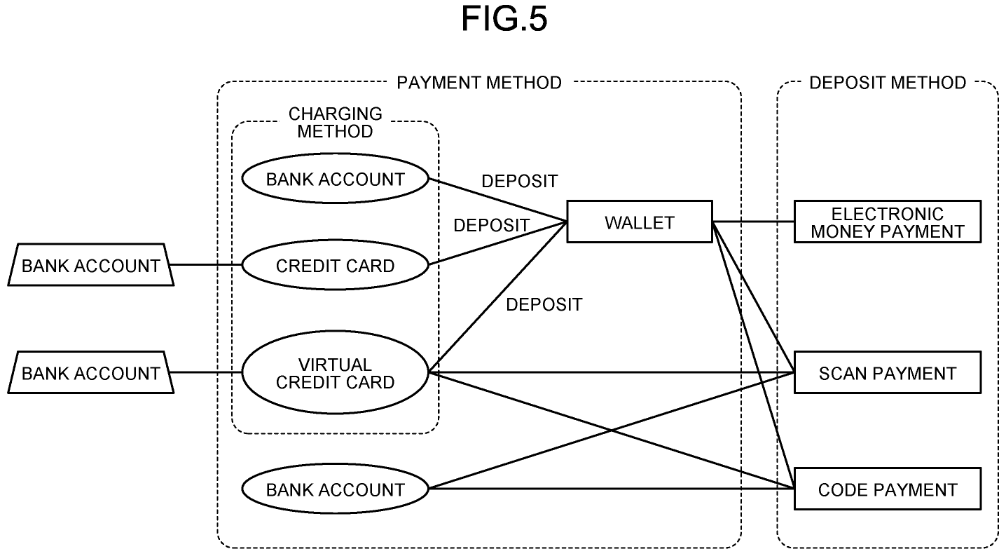

FIG. 5 is a diagram schematically illustrating a relationship between the payment methods, the deposit methods, and the settlement methods. The “payment method” refers to a method that serves as a funding source when a settlement is made. Examples of the payment method include bank accounts, credit cards, virtual credit cards, and electronic money balances in wallets. A virtual credit card is an insubstantial credit card, and includes information such as a card number, an expiry date, and an authentication number (security code). In addition, a bank account is linked to each of the credit card and the virtual credit card, and a use amount of each card is withdrawn from the bank account at a later date.

The “deposit method” refers to a method of depositing electronic money to a wallet, which is a virtual deposit/withdrawal account. Examples of the deposit method include bank accounts, credit cards, and virtual credit cards out of the payment methods. By registering a bank account, a credit card, and a virtual credit card as deposit methods, deposit of electronic money into a wallet becomes possible.

The “settlement method” refers to a method of making a settlement using a payment method. Examples of the settlement method may include electronic money payment, scan payment, and code payment. Electronic money payment is a settlement made when the user terminal 30 is held over a predetermined position of the vehicle 40 without a contact between the short-range wireless communication unit 34 of the user terminal 30 and a short-range wireless communication unit 46 of the vehicle 40. Scan payment is a settlement made when a barcode or QR code (registered trademark) displayed on the vehicle 40 is read with a camera or the like of the user terminal 30. Code payment is a settlement made when a barcode or QR code (registered trademark) displayed on the user terminal 30 is read by a code reader or the like of the vehicle 40.

In the wallet system 1, any of the settlement methods of three types may be used by using the payment methods of three types. That is, in the wallet system 1, the payment methods and the settlement methods may be combined as described in (1) to (3) below.

(1) Electronic money payment, scan payment, and code payment using an electronic money balance in the wallet

(2) Electronic money payment, scan payment, and code payment using a virtual credit card

(3) Electronic money payment, scan payment, and code payment using a bank account

In the wallet system 1 of the present embodiment, it is possible to deposit electronic money to a wallet by a plurality of payment methods, and it is possible to make a settlement from the electronic money balance deposited to the wallet through a plurality of settlement methods.

FIG. 4 is referred again. The settlement method registration unit 313 registers the payment methods to be registered as deposit methods also as settlement methods. That is, when a deposit method registration request is transmitted from the deposit method registration unit 312 to the wallet server 10, the settlement method registration unit 313 transmits a settlement method registration request, which causes the payment methods included in the deposit method registration request to be registered as settlement methods, to the wallet server 10.

For example, when the settlement method registration unit 313 registers a payment method (a bank account of bank A) as a deposit method, the settlement method registration unit 313 automatically registers the payment method (the bank account of bank A) also as a settlement method. Note that “registering a payment method as a settlement method” means enabling a settlement using the payment method as a payment source, and means, for example, enabling electronic money payment, scan payment, and code payment using a bank account of bank A as a payment source. The control unit 11 of the wallet server 10 that has received the settlement method registration request from the settlement method registration unit 313 stores the payment methods included in the settlement method registration request as the user information 131 in the memory 13, thereby registering the payment methods as the settlement methods.

The deposit processing unit 314 deposits electronic money to the wallet. Specifically, the deposit processing unit 314 transmits a deposit request to the wallet server 10 for depositing electronic money to the wallet by a payment method registered as a deposit method. The control unit 11 of the wallet server 10 that has received the deposit request from the deposit processing unit 314 increases the electronic money balance in the wallet based on deposit amount information included in the deposit request. That is, the control unit 11 updates the wallet information 132 stored in the memory 13 according to the increased amount of the electronic money balance in the wallet.

The settlement processing unit 315 makes a settlement by a payment method. The settlement processing unit 315 transmits a settlement request to the vehicle 40 to be ridden for making a settlement using any of a plurality of preset settlement methods (electronic money payment, scan payment, code payment) using electronic money deposited in the wallet. For example, when electronic money payment is made, the settlement processing unit 315 transmits a settlement request to the vehicle 40 through the short-range wireless communication unit 34. When scan payment is made, the settlement processing unit 315 transmits a settlement request to the vehicle 40 by reading a barcode or QR code (registered trademark) displayed on the vehicle 40 with the camera or the like of the user terminal 30. When code payment is made, the settlement processing unit 315 transmits a settlement request to the vehicle 40 by having the code reader or the like of the vehicle 40 read a barcode or QR code (registered trademark) displayed on the user terminal 30. The settlement request transmitted from the settlement processing unit 315 to the vehicle 40 may, but does not have to, include information indicating a settlement amount (hereinafter, referred to as “settlement amount information”).

Subsequently, a control unit 41 of the vehicle 40 transmits a settlement request including the settlement amount information to the wallet server 10 via the network 2. The settlement processing unit 111 of the wallet server 10 that has received the settlement request from the vehicle 40 reduces the electronic money balance in the wallet based on the settlement amount information included in the settlement request. That is, the settlement processing unit 111 updates the wallet information 132 and the settlement information 133 stored in the memory 13 according to the reduced amount of the electronic money balance in the wallet.

The settlement processing unit 315 may also make a settlement by a payment method other than the electronic money balance in the wallet (for example, a bank account or a credit card). In this case, the settlement processing unit 315 transmits a settlement request to the wallet server 10 for making a settlement using any of a plurality of settlement methods by a bank account or a credit card. The settlement processing unit 111 of the wallet server 10 that has received the settlement request from the settlement processing unit 315 transmits the settlement amount information included in the settlement request to the settlement company server 20.

The memory 33 stores data of various screens displayed on the operation/display unit 35 by the display control unit 311. Further, in the memory 33, the user information 131, the wallet information 132, the settlement information 133, and the like are continuously or temporarily stored as needed.

The short-range wireless communication unit 34 has a communication function conforming to a standard such as near field radio communication (NFC), Bluetooth (registered trademark) low energy (BLE), or infrared data association (IrDA), for example. For example, when electronic money payment is made, the user terminal 30 performs short-range wireless communication with the vehicle 40 through the short-range wireless communication units 34 and 46.

The operation/display unit 35 includes, for example, a touch panel display, and has an input function for accepting an operation by a user's finger, a pen, or the like and a display function for displaying various types of information based on the control by the display control unit 311.

The position information acquisition unit 36 receives, for example, a radio wave from a global positioning system (GPS) satellite and detects the position of the user terminal 30. Information about the position of the user terminal 30 detected by the position information acquisition unit 36 is stored in the memory 33.

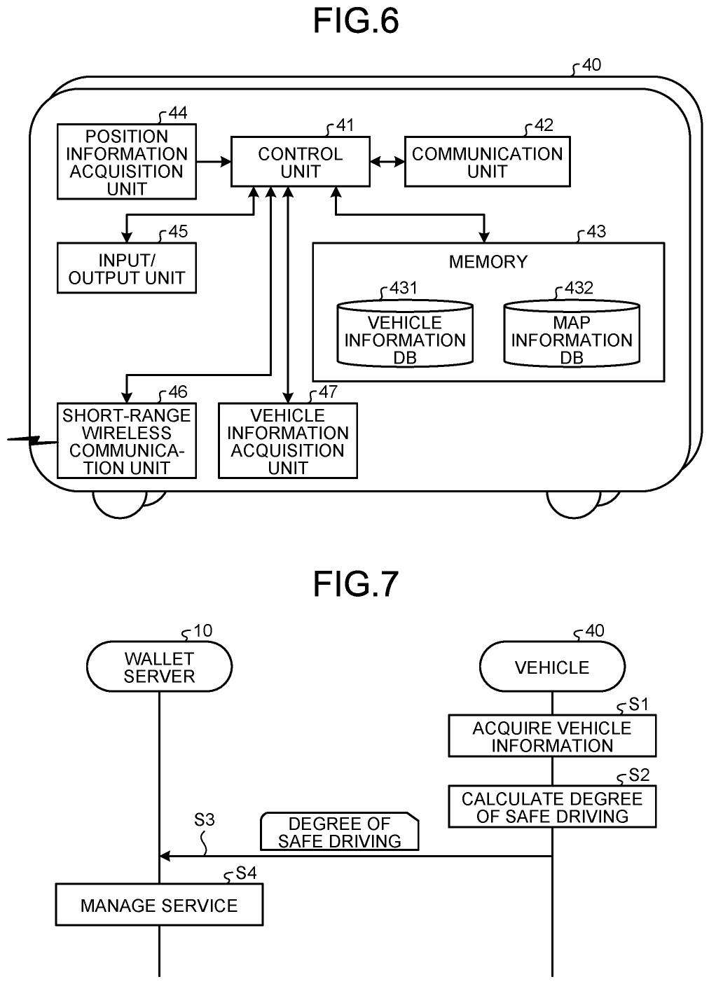

The vehicle 40 is a vehicle that travels by driving by a driver, or an autonomous traveling vehicle that is configured to autonomously travel according to a given traveling instruction. As illustrated in FIG. 6, the vehicle 40 includes a control unit 41, a communication unit 42, a memory 43, a position information acquisition unit 44, an input/output unit 45, the short-range wireless communication unit 46, and a vehicle information acquisition unit 47.

The control unit 41, the communication unit 42, the memory 43, and the short-range wireless communication unit 46 have physical configurations similar to the control unit 11, the communication unit 12, the memory 13, and the short-range wireless communication unit 34, respectively.

The control unit 41 collectively controls the operations of various components mounted on the vehicle 40.

The communication unit 42 includes a data communication module (DCM) or the like that performs information communication with the wallet server 10 by wireless communication via the network 2.

The memory 43 includes a vehicle information database (vehicle information DB) 431 and a map information database (map information DB) 432. In the vehicle information DB 431, various types of information including a user ID of the driver of the vehicle 40 and the vehicle information acquired by the vehicle information acquisition unit 47, and the like are stored in an updatable manner.

The map information DB 432 stores map information. Here, the map information is information necessary for identifying the positions of roads, road structures, facilities, and the like, and includes, for example, data related to each node set on a road (for example, node ID, coordinates, etc.), data related to each link set on a road (for example, link ID, link name, connection node ID, road coordinates, road type (toll road, local road, etc.), the number of lanes, etc.), and feature data (for example, traffic lights, road signs, guard rails, facilities, etc.), and the like.

The position information acquisition unit 44 has a physical configuration similar to that of the position information acquisition unit 36. The position information of the vehicle 40 detected by the position information acquisition unit 44 is stored in the vehicle information database 431 so as to be retrievable. As a method of detecting the position of the vehicle 40, a method obtained by combining light detection and ranging, laser imaging detection and ranging (LiDAR) and a three-dimensional digital map may be adopted.

The input/output unit 45 includes a touch panel display, a speaker microphone, or the like. The input/output unit 45 as output means is configured such that input/output unit 45 may notify the outside of predetermined information by displaying characters, figures, etc. on the screen of the touch panel display or outputting voice from the speaker microphone according to the control by the control unit 41. Further, the input/output unit 45 as input means is configured to be able to input predetermined information to the control unit 41 by a user operating the touch panel display or projecting voice toward the speaker microphone. In the present embodiment, the vehicle 40 includes the position information acquisition unit 44 and the input/output unit 45 as separate functions, but the vehicle 40 may include an in-vehicle navigation system with a communication function having both functions of the position information acquisition unit 44 and the input/output unit 45 instead of the position information acquisition unit 44 and the input/output unit 45.

The short-range wireless communication unit 46 has a communication function conforming to a standard such as NFC, BLE, or IrDA, for example, and is provided at a predetermined position of the vehicle 40. When, for example, a user makes electronic money payment, the user holds the user terminal 30 over a predetermined position, whereby short-range wireless communication is performed with the user terminal 30 through the short-range wireless communication unit 46.

The vehicle information acquisition unit 47 acquires vehicle information from the vehicle 40 when the vehicle 40 is traveling, and stores the vehicle information acquired via the control unit 41 in the vehicle information DB 431. The vehicle information includes information such as a vehicle ID of the vehicle 40, vehicle speed, sudden deceleration, sudden acceleration, sudden steering, an operating state of safety equipment (ABS, tire slip prevention device, sideslip prevention device, etc.), steering change amount, brake operation change amount, accelerator operation change amount, and the like.

The wallet system 1 having such a configuration improves the quality of a car sharing service by performing service management processing described below.

Hereinafter, an operation of the wallet system 1 when the service management processing is performed will be described with reference to FIG. 7.

FIG. 7 is a timing chart illustrating a flow of service management processing. The timing chart illustrated in FIG. 7 starts at the timing when the ignition switch of the vehicle 40 is switched from the off state to the on state, and the service management processing proceeds to processing of step S1.

In the processing of step S1, the vehicle information acquisition unit 47 of the vehicle 40 acquires vehicle information, and stores the vehicle information acquired via the control unit 41 in the vehicle information DB 431. Thus, the processing of step S1 is completed, and the service management processing proceeds to processing of step S2.

In the processing of step S2, the control unit 41 of the vehicle 40 reads vehicle information from the vehicle information DB 431, and calculates the degree of safe driving of the vehicle 40 by the driver using the read vehicle information. The degree of safe driving is calculated based on, for example, information such as vehicle speed, sudden deceleration, sudden acceleration, sudden steering, and operating state of safety equipment included in vehicle information. For example, the degree of safe driving is calculated to be lower as a user travels at a speed exceeding the legal speed or decelerates suddenly more often. Thus, the processing of step S2 is completed, and the service management processing proceeds to processing of step S3.

In the processing of step S3, the control unit 41 of the vehicle 40 transmits, to the wallet server 10 via the communication unit 42, degree of safe driving information including the information about the degree of safe driving calculated in the processing of step S2, information for identifying the vehicle 40 owned by a driver, and information for identifying the driver of the vehicle 40. Thus, the processing of step S3 is completed, and the service management processing proceeds to processing of step S4.

In the processing of step S4, the control unit 11 of the wallet server 10 receives the degree of safe driving information via the communication unit 12, and determines, based on the received degree of safe driving information, whether the vehicle 40 owned by the driver may be provided to a car sharing service. Specifically, the control unit 11 calculates a score of the driver using the degree of safe driving, and when the calculated score is equal to or higher than a predetermined value, the control unit 11 determines that the vehicle 40 owned by the driver may be provided to the car sharing service. Then, in a case where the control unit 11 determines that the vehicle 40 owned by the driver may be provided to the car sharing service, the control unit 11 notifies the user terminal 30 or the vehicle 40 owned by the driver to that effect, and sets the car sharing service such that the vehicle 40 owned by the driver may be reserved. After that, the wallet server 10 performs settlement processing of the fee for the car sharing service with the user terminal 30 carried by a user who uses the car sharing service via a settlement application program. When the vehicle 40 is provided to a car sharing service, the driver may set a degree of safe driving and a score of a user who rents the vehicle 40, and the control unit 11 may select a user to whom the vehicle 40 is rented out based on the set degree of safe driving and score. Further, a traveling mode, in which a score may be earned (safe driving mode) may be provided on the vehicle 40 side to promote safe driving. Thus, the processing of step S4 is completed, and the series of service management processing ends.

As is clear from the above description, in the service management processing according to the present disclosure, the vehicle 40 calculates the degree of safe driving of the vehicle 40 by the driver and outputs information about the calculated degree of safe driving, and the wallet server 10 acquires information about the degree of safe driving and determines whether to provide the vehicle 40 to the car sharing service based on the acquired information. According to the configuration described above, it is possible to prevent a situation where any user may provide a vehicle to a car sharing service, and thus, the quality of a car sharing service may be improved. As a result, the number of users who drive safely increases, which may contribute to society.

According to the present disclosure, it is possible to provide a car sharing system, a server and a computer readable recording medium that improve the quality of a car sharing service.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A car sharing system comprising:
a vehicle comprising a first processor comprising hardware, the first processor being configured to
calculate a degree of safe driving of the vehicle by a driver, and
output information about the calculated degree of safe driving; and
a server comprising a second processor comprising hardware, the second processor being configured to
acquire the information about the degree of safe driving, and
determine whether to provide the vehicle to a car sharing service based on the acquired information.

2. The car sharing system according to claim 1, wherein the second processor is configured to:
calculate a score of the driver based on the degree of safe driving; and
provide the vehicle to the car sharing service in a case where the calculated score is equal to or higher than a predetermined value.

3. The car sharing system according to claim 1, wherein the first processor is configured to calculate the degree of safe driving by using at least one of: a vehicle speed; a steering change amount; a brake operation change amount; and an accelerator operation change amount.

4. The car sharing system according to claim 1, wherein the second processor is configured to select a user to whom the vehicle is rented out in the car sharing service based on the degree of safe driving of the user.

5. The car sharing system according to claim 1, wherein the second processor is configured to perform settlement processing of a fee of the car sharing service.

6. The car sharing system according to claim 5, wherein the second processor is configured to perform the settlement processing by electronic money payment.

7. The car sharing system according to claim 5, wherein the second processor is configured to perform the settlement processing by scan payment.

8. The car sharing system according to claim 5, wherein the second processor is configured to perform the settlement processing by code payment.

9. The car sharing system according to claim 5, wherein the second processor is configured to perform the settlement processing according to a settlement application program.

10. A server comprising
a processor comprising hardware, the processor being configured to:
acquire information about a degree of safe driving of a driver of a vehicle; and
determine whether to provide the vehicle to a car sharing service based on the acquired information.

11. The server according to claim 10, wherein the processor is configured to:
calculate a score of the driver based on a degree of safe driving; and
provide the vehicle to the car sharing service in a case where the calculated score is equal to or higher than a predetermined value.

12. The server according to claim 10, wherein the degree of safe driving is calculated by using at least one of: a vehicle speed; a steering change amount; a brake operation change amount; and an accelerator operation change amount.

13. The server according to claim 10, wherein the processor is configured to select a user to whom a vehicle is rented out in the car sharing service based on the degree of safe driving of the user.

14. The server according to claim 10, wherein the processor is configured to perform settlement processing of a fee of the car sharing service.

15. The server according to claim 14, wherein the processor is configured to perform the settlement processing according to a settlement application program.

16. A non-transitory computer-readable recording medium on which an executable program is recorded, the program causing a processor of a computer to execute:
acquiring information about a degree of safe driving of a driver of a vehicle; and
determining whether to provide the vehicle to a car sharing service based on the acquired information.

17. The non-transitory computer-readable recording medium according to claim 16, wherein the program causes the processor to execute:
calculating a score of the driver based on the degree of safe driving; and
providing the vehicle to the car sharing service in a case where the calculated score is equal to or higher than a predetermined value.

18. The non-transitory computer-readable recording medium according to claim 16, wherein the degree of safe driving is calculated by using at least one of: a vehicle speed; a steering change amount; a brake operation change amount; and an accelerator operation change amount.

19. The non-transitory computer-readable recording medium according to claim 16, wherein the program causes the processor to execute selecting a user to whom a vehicle is rented out in the car sharing service based on the degree of safe driving of the user.

20. The non-transitory computer-readable recording medium according to claim 16, wherein the program causes the processor to execute performing settlement processing of a fee of the car sharing service.
